(19) United States
(12) Patent Application Publication
(10) Pub. No.: US 2005/0175405 A1
(43) Pub. Date: Aug. 11, 2005

(54) Fitting for connecting hollow plates

(76) Inventors: Rudiger Walz, Haigerloch (DE); Gerd Sawatzki, Rauen (DE)

Correspondence Address: Friedrich Kueffner;Suite 910, 317 Madison Avenue, New York, NY, 10017, US

(21) Appl. No.: 11/029,818

(22) Filed: Jan. 5, 2005

(30) Foreign Application Priority Data
Jan. 14, 2004 (DE) 20 2004 000 473

(51) Int. Cl. H01F 27/02

(52) U.S. Cl. 403/350

(57) ABSTRACT

A fitting for connecting hollow plates, particularly honeycomb plates, sandwich plates, or the like, includes a clamping part which is rotatably mounted in a housing and which receives the head of a corresponding tightening bolt which is provided with threads at the free end thereof. A guide tube for a tightening bolt having an extended length is provided on the housing. The guide tube may consist of a single piece with the housing.

### BACKGROUND OF THE INVENTION

1. Field of the Invention

The present invention relates to a fitting for connecting hollow plates, particularly honeycomb plates, sandwich plates or the like.

2. Description of the Related Art

Plates of the above-described type are composed of two relatively thin cover plates of high strength, wherein the hollow space between the cover plates is filled out with corrugated cardboard or a similar material. While in the case of solid plates the fittings can be inserted in bores of the plates or can be screwed to the plates in a simple manner, the fittings or screws do not find support within the hollow spaces of the hollow plates, so that fastening of the fittings is limited to the cover plates. However, since these cover plates are relatively thin, special precautions have to be taken in order to prevent breaking of the cover plates.

### SUMMARY OF THE INVENTION

Therefore, it is the primary object of the present invention to provide a fitting which is particularly suitable for connecting hollow plates.

In a connecting fitting with a clamping part which is rotatably supported in a housing and which receives the head of a corresponding tightening bolt which has threads at its free end, the above object is met by fastening a guide tube for an extended tightening bolt to the housing.

As a result of the configuration according to the present invention, the cutout in the cover plate for the housing is located a distance away from the edge of the housing, so that the danger of tearing of the cutout at the edge of the cover plate is prevented. The guide tube provides for a problem-free guidance and support of the tightening bolt, so that the tightening bolt can be inserted without difficulties into the corresponding bore of the hollow plate to be connected.

In order to simplify the manufacture of the fitting, the guide tube and the housing are preferably composed of a single piece. In order to further the strengthen the connection of the fitting with the hollow plate, another feature of the present invention provides that at the free end of the guide tube a support housing is arranged which has a passage for the tightening bolt and is received in a second cutout of the hollow plate. In this embodiment of the housing, it is advantageous to connect the housing with the support housing through a fastening plate arranged above the cover plate. In order to further reinforce the hollow plate in the areas of the cutouts, the tube has longitudinally extending webs which extend perpendicularly of the tube. The longitudinal webs rest against the cover plates of the hollow plate.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective exploded view of a connecting fitting;

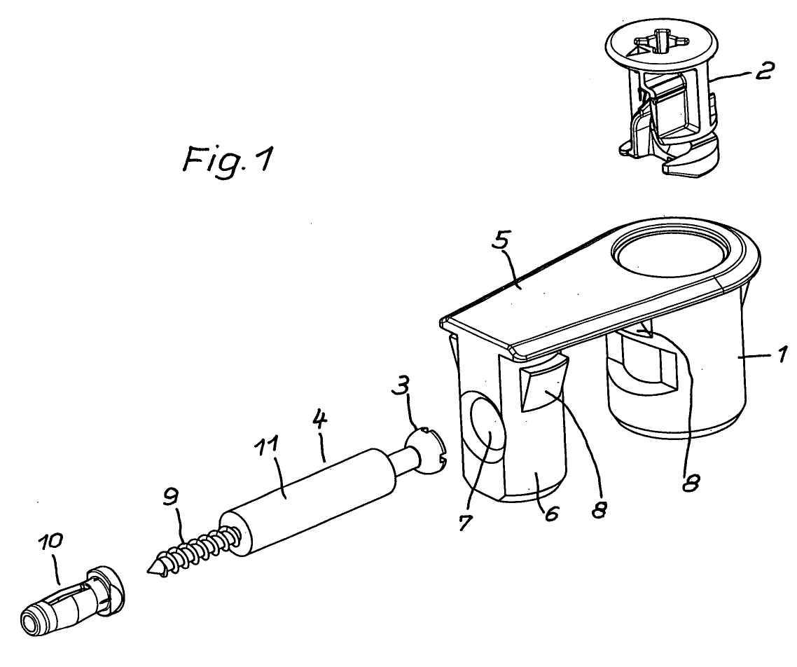

FIG. 2 is a perspective view, on a larger scale, showing the fitting in the assembled state;

FIG. 3 is an illustration of two honeycomb plates connected with a connecting fitting according to FIG. 1;

FIG. 4 is an illustration similar to FIG. 3, showing another embodiment of the fitting; and

FIG. 5 is an illustration similar to FIG. 3, showing yet another connecting fitting.

### DETAILED DESCRIPTION OF THE INVENTION

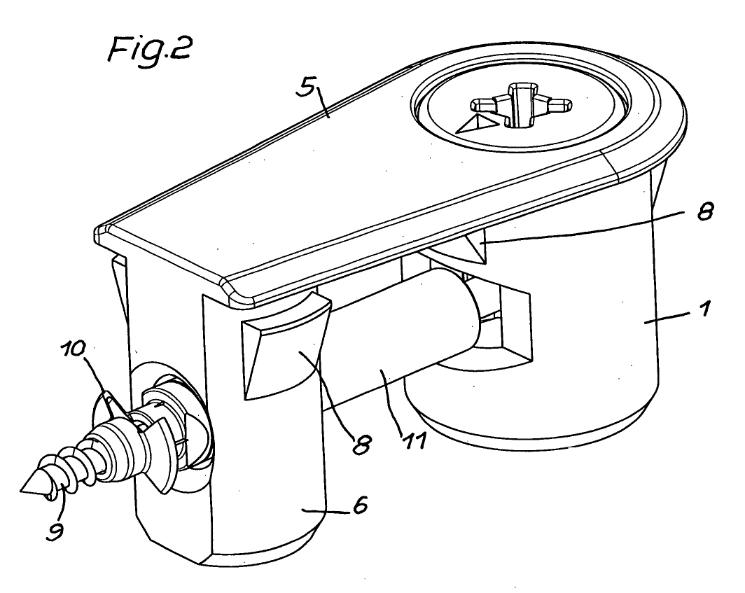

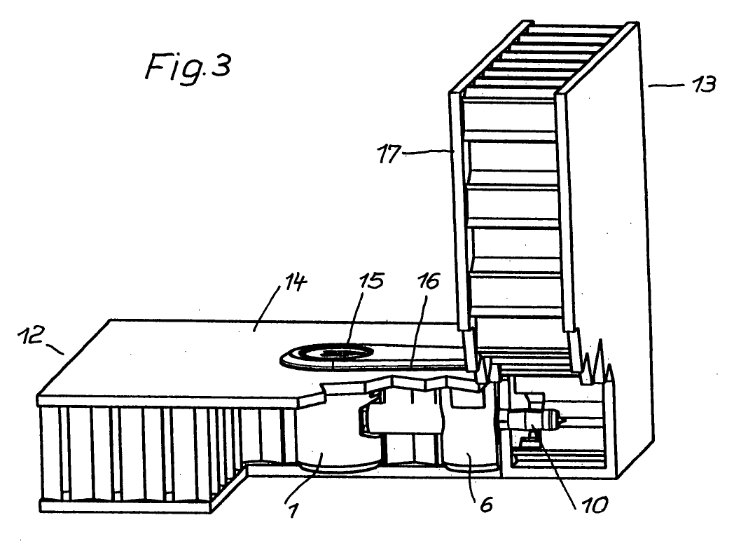

A connecting fitting according to the present invention, as illustrated in the drawing, includes a housing 1 with a clamping part 2 for the head 3 of a tightening bolt 4, wherein the clamping part 2 is rotatably mounted in the housing 1. In addition, the housing 1 is connected through a plate 5 to a support housing 6. The support housing 6 includes a passage 7 for the tightening bolt 4. Also, barb-like or hook-shaped elastically pivotable wings 8 are provided at both housings 1, 6, wherein the wings 8 serve for the support at the cover plate 14 of a honeycomb plate 12, as seen in FIG. 3. The free end of the tightening bolt 4 is provided with a thread 9 which engages in an expanding sleeve 10. In FIG. 2 showing the assembled state, the individual parts are joined and the expanding sleeve 10 is folded out. The housing 1 and the support housing 6 are additionally connected through a guide tube 11 which is placed on the tightening bolt 4.

As seen in FIG. 3, two honeycomb plates 12 and 13 are connected to one another by means of the connecting fitting according to the present invention. As shown in FIG. 3, cutouts 15 and 16 are provided for the housing 1 and the support housing 6 in the cover plate 14 of the honeycomb plate 12. The expansion sleeve 10, which is folded out, rests on the inside against the cover plate 17 of the honeycomb plate 13. Due to the great distance of the housing 1 with the clamping member 2 from the free edge of the cover plate 14, tearing of the cover plate 14 is practically excluded, wherein additionally the support housing 6 and primarily also the plate 5 contribute to the prevention of tearing.

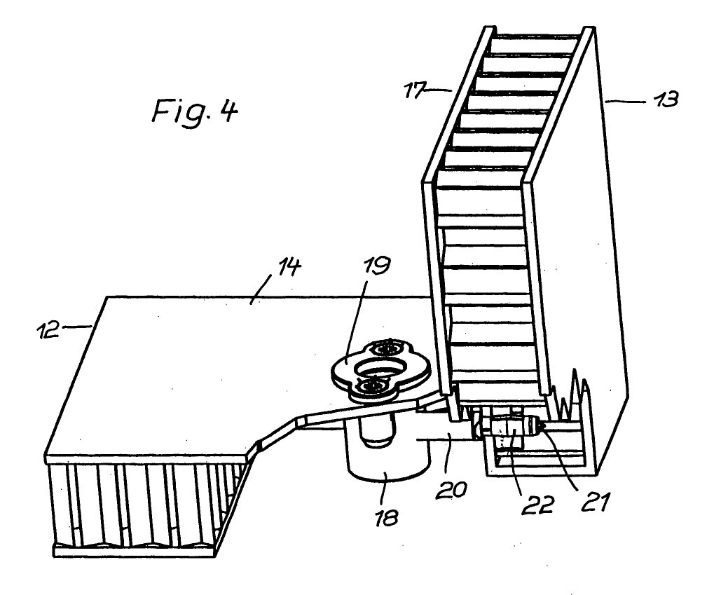

FIG. 4 of the drawing shows another embodiment in which the support housing 6 has been omitted and only a housing 18 with a clamping member, not illustrated in the drawing, is provided. This housing 18 is connected above the cover plate 14 of the honeycomb plate 12 by means of a flange 19. In order to achieve also in this case a distance from the end edge of the cover plate 14 which is as large as possible, a guide tube 20 is provided for a tightening bolt 21, wherein the tightening bolt 21, in turn, is secured by means of an expanding sleeve 2 on the inside against the cover plate 17 of the honeycomb plate 13.

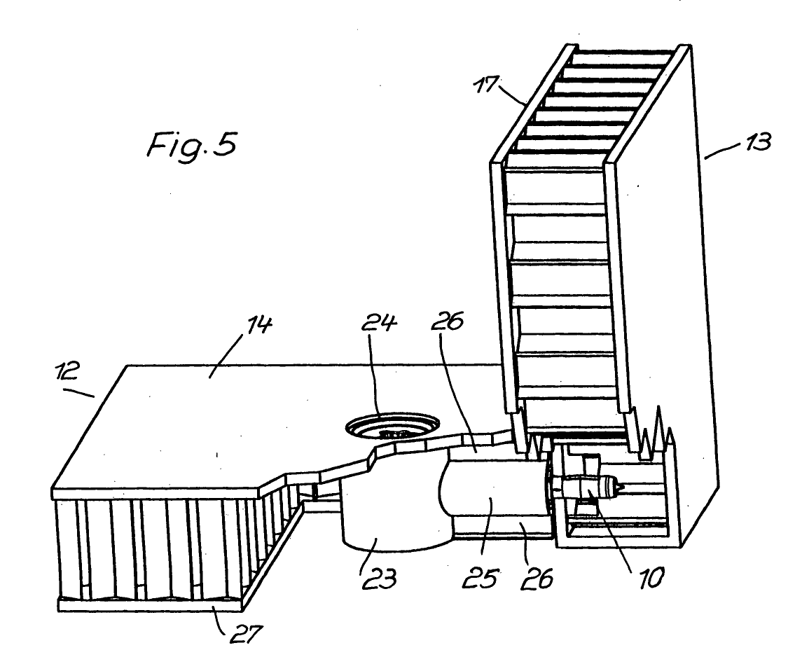

In the embodiment of FIG. 5, the housing 23 is placed without fastening plate in a cutout 24 of the cover plate 14 of the honeycomb plate 12. In order to still achieve a secure connection, the guide tube 25 additionally has longitudinal webs 26 which extend perpendicularly of the honeycomb plate 12 and which rest against the two cover plates 14 and 17 of the honeycomb plate 12.

The invention is not limited by the embodiments described above which are presented as examples only but can be modified in various ways within the scope of protection defined by the appended patent claims.

1. A fitting for connecting hollow plates, especially honeycomb plates or sandwich plates, the fitting comprising a housing and a clamping part rotatably mounted in the housing, further comprising a tightening bolt having a head and a free end, wherein the head of the tightening bolt is received in the clamping part and the free end of the tightening bolt has threads, further comprising a guide tube attached to the housing for receiving a tightening bolt having an increased length.

2. The fitting according to claim 1, wherein the guide tube is composed of a single piece with the housing.

3. The fitting according to claim 1, wherein a support housing received in a cutout of the hollow plate is arranged at the free end of the guide tube, wherein the support housing is provided with a passage for the tightening bolt.

4. The fitting according to claim 3, wherein the housing and the support housing are connected to each other by a fastening plate located above the hollow plate.

5. The fitting according to claim 1, wherein the guide tube has longitudinal webs extending perpendicularly of the hollow plate, wherein the longitudinal webs rest against both cover plates of the hollow plate.
